(19) United States
(12) Patent Application Publication
(10) Pub. No.: US 2007/0078778 A1
(43) Pub. Date: Apr. 5, 2007

(54) Cellular connectivity for a franking machine

(76) Inventor: Mark Ferraro, Hamden, CT (US)

Correspondence Address: KENYON & KENYON LLP, 1500 K STREET N.W., SUITE 700, WASHINGTON, DC, 20005, US

(21) Appl. No.: 11/243,067

(22) Filed: Oct. 4, 2005

(51) Int. Cl. G06Q 99/00

(52) U.S. Cl. 705/60

(57) ABSTRACT

A method of connecting a service provider to a franking machine. The method is provided having steps of: providing a franking machine at a first location, the franking machine having a communication interface; providing a server at a central location remote from the first location; connecting a cellular interface to the communication interface of the franking machine; and establishing a secure channel of communication between the cellular interface and the server.

### BACKGROUND

1. Field

The exemplary embodiments and methods described herein relate to cellular connectivity for a franking machine.

2. Brief Description of Related Developments

Mailing machines enable users to frank one or more mail items by printing a stamp representing the amount paid by the sender. For example, U.S. Pat. Nos. 5,243,908; 5,683,190; 5,526,271; 6,607,095; 6,050,054; 5,293,465; 5,688,729; all of which are incorporated herein by reference in their entirety; disclose franking machines which may comprise franking heads, feeders, folders and user interfaces as examples. With franking machines aspects, such as device security and PKI Key management require secure communication between a service provider and the franking machine user. Typically, this secure communication is established over the users LAN (Local Area Network) or analog phone lines. A problem arises when the LAN is down or firewall access prevents the service provider to access the franking machines for critical items such as periodic required resets. A further problem arises where there are insufficient phone lines requiring the user to move individual franking machines to the line. Accordingly, there is a desire to provide a simple and cost effective method of securely connecting a service provider to franking machines.

### SUMMARY OF THE EXEMPLARY EMBODIMENTS

In accordance with one exemplary embodiment, a method of connecting a service provider to a franking machine is provided having steps of: providing a franking machine at a first location, the franking machine having a communication interface; providing a server at a central location remote from the first location; connecting a cellular interface to the communication interface of the franking machine; and establishing a secure channel of communication between the cellular interface and the server.

In accordance with another exemplary embodiment, a method of resetting franking machines is provided having steps of: providing a first and second franking machine at a first location; providing a server at a central location remote from the first location; connecting a cellular interface to the first franking machine; establishing a secure channel of communication between the cellular interface and the server; resetting the first franking machine from the server over the secure channel; connecting the cellular interface to the second franking machine; and resetting the second franking machine from the server over the secure channel.

In accordance with another exemplary embodiment, a method of resetting a franking machine is provided having steps of: providing a franking machine at a first location, the franking machine having a cellular communication interface; providing a server at a central location remote from the first location; establishing communication via an encrypted channel between the franking machine and a cellular carrier; routing the communication to the server at the central location; and resetting the franking machine from the central location via the encrypted channel.

### BRIEF DESCRIPTION OF THE DRAWINGS

The foregoing aspects and other features of the present invention are explained in the following description, taken in connection with the accompanying drawings, wherein:

FIG. 1 shows a block diagram of a system in which the method of the present invention could be utilized;

FIG. 2 shows a block diagram of a franking device in which the method of the present invention could be utilized;

FIG. 3 shows a block diagram of a communication interface of a franking device in which the method of the present invention could be utilized;

FIG. 4 shows a flow diagram of a method of the present invention.

### DETAILED DESCRIPTION OF THE EXEMPLARY EMBODIMENTS

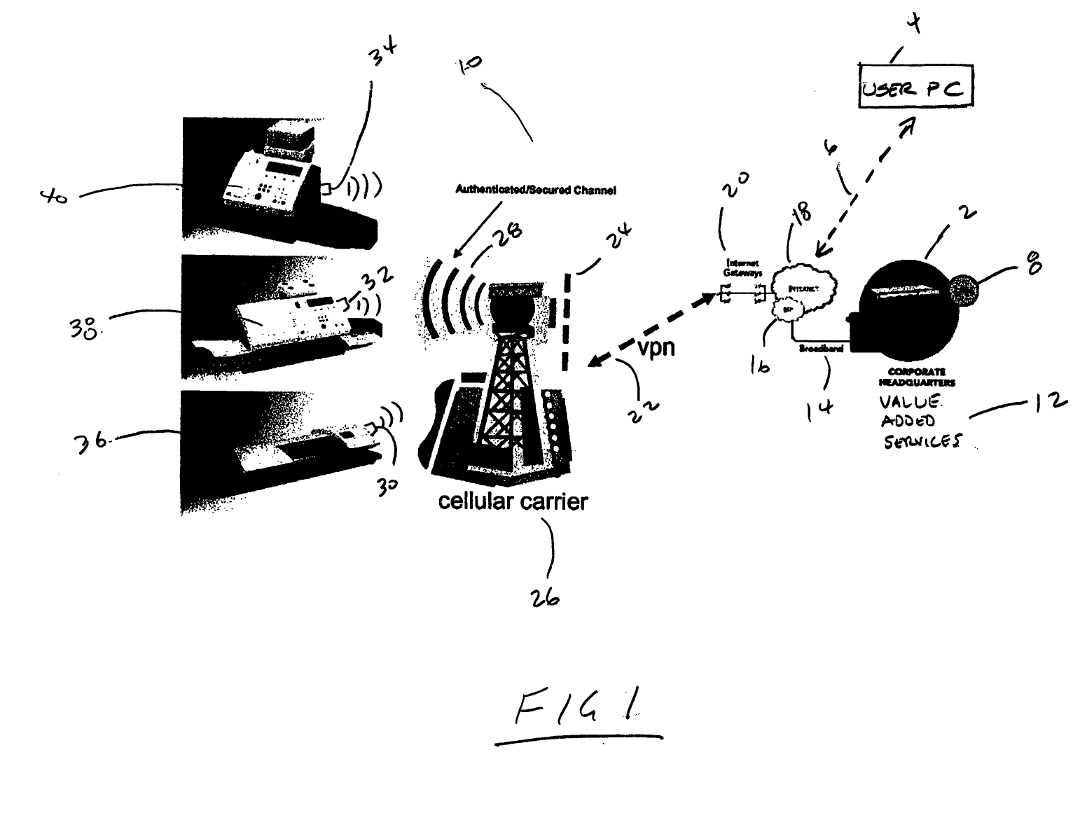

Referring to FIG. 1, there is shown a block diagram of a system 10 in which the method of the exemplary embodiments could be utilized. Although the present invention will be described with reference to the exemplary embodiments shown in the drawings, it should be understood that the present invention can be embodied in many alternate forms of embodiments. In addition, any suitable size, shape or type of elements or materials could be used.

FIG. 1 shows a system diagram 10 where franking machines 36, 38, 40 communicate via GPRS 28 to a cellular carrier 26. Here the franking machine(s) may be authenticated via the GSM system whereby a secure encrypted channel is established. Here, the cellular carrier 26 may route the call via a secure network 22, for example a VPN or virtual private network, to the service provider 2, for example Neopost via gateways 20, internet 18, ISP 14 or otherwise. In the embodiment shown, GSM providers/clients are required to implement authentication/secure communications. Communications security may then be based on a worldwide implemented/supported standard. As a result of the cellular communication, firewall and network issues are eliminated at the customer site. Here, the communication channel may always be open. In the embodiment shown, cellular connectivity 30, 32, 34 may be provided, for example, as an optional upgrade for franking machines 36, 38, 40 already deployed in the field at a given site(s). Cellular communication may be taken advantage of, for example, as a standard to reduce the cost of doing business leveraging it, for example, for device security, PKA management where device communication between franking machines 36, 38, 40 and value added services 12 is implemented at the same or different remote sites. For example, a channel may be provided that is always on for constant communication between the value added services and the device or franking machine where the cellular based communication eliminates customer or user LAN issues, for example, firewalls, availability and access issues. Analog lines may be provided in offices where such lines may be scarce and where they may also be costly. For example, a franking machine may need an analog line for doing secure encrypted functions, for example such as resets or key resets where a new public/private may be established by individual. Here, security needs to be maintained to prevent corruption whereby periodic updates are required. Such updates, for example, require secure communication. In alternate embodiments, other secure or unsecure communications may be applied to other secure or unsecure functions. Alternately, a LAN may be used where customer network issues with firewalls may arise. In the present embodiment, cellular based connectivity is provided to the franking machine(s) to avoid such network or firewall issues. Here, the infrastructure that is used, for example, with cell phones may be applied to franking machines to connect securely, for example, to the reset service provider 12 infrastructure. Franking machines 36, 38, 40 may be provided with the cellular connectivity integrated into the machines. Alternately, current fielded machines may be modified, for example, with or without software change by connecting to a separate port or removing the modem and adding an adapter board that would interpret some of the modem dial up connectivity calls and pass through the rest of the information unchanged. Here, a cost effective adaptation is provided. For example, in the case of a field upgrade, franking machine 40 may have a main board having a port, for example, a RS232 connector attached to a modem. Franking machine 40 may be upgraded or new systems provided by removing the modem and attaching an adapter 34 having a cellular modem, for example, GSM in particular, to the franking machine. Here, the adapter may do the handling for the dial-up allowing communication to pass through. Alternately, the franking machine may be configurable or provided with multiple communication mechanisms, for example, analog dial up, GSM, LAN or otherwise and be capable to know the difference between a modem and a GSM modem, where an adapter is not required.

As shown in FIG. 1, a system 10 is provided where the franking machine(s) 30, 32, 34 connect through a cellular carrier 26. The connection between the franking machine(s) 36, 38, 40 and the cellular carrier 26 may be authenticated and the channel(s) 28 may then be an encrypted, secure channel 28. Such secure connection 28 may be provided via the cellular carriers, where the cellular carrier may rout the call via a VPN 22 to the service 12, for example, to reset provider (Neopost) 2, where the data is processed. The GSM provider 26 and the clients may implement the appropriate security level, for example, where such security schemes may be implemented worldwide as a standard that may be leveraged to eliminate access via conventional methods, such as firewalls and analog lines. The communication 30, 32, 34 may be provided in an “always on” state whereby when the system franking machine can handle incoming messages, such messages may be provided. Alternately, in a typical mailroom environment insufficient analog lines may be provided where the users are required to frequently move franking machines to the analog lines to do resets. Here, the modem 34 may alternately be removed from the franking machine 40 and put, for example, in a harness such that a connection externally with cellular modem may be provided where the user may move the cellular modem from machine 40 to machine 38 connected to the franking machine 38 where all the resets for the various machines may be performed without having to move the machine(s) providing an increased utilization and improved machine usability. Here, the cost associated, for example, with an analog line or multiple analog lines may be shifted elsewhere, for example, to the cost of reset budget service or rental cost of PSD or some service. Here, cellular providers 26 may have telemetry plans that allow a user to subscribe at a reduced cost. In this manner, cellular wireless communication may be taken advantage of to reduce the cost of doing business. Example applications include device communication security and PKI management or otherwise where cost and complexity is reduced. Here, the device communication channel may always be on line and customer LAN issues may be eliminated. In alternate embodiments, periodic communication access may be applied. In one embodiment, the technology may be implemented with minimal or no hardware or software changes to existing, installed franking machines. Here, mobile communication is applied to franking machines 36, 38, 40, such as through global system for mobile communication (GSM) 28 as a cellular solution for connectivity. Here, the hardware and connectivity costs may be significantly lower as compared to analog or networked lines.

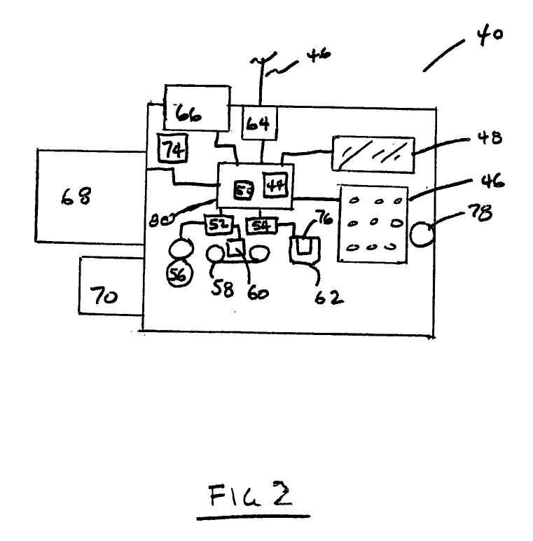

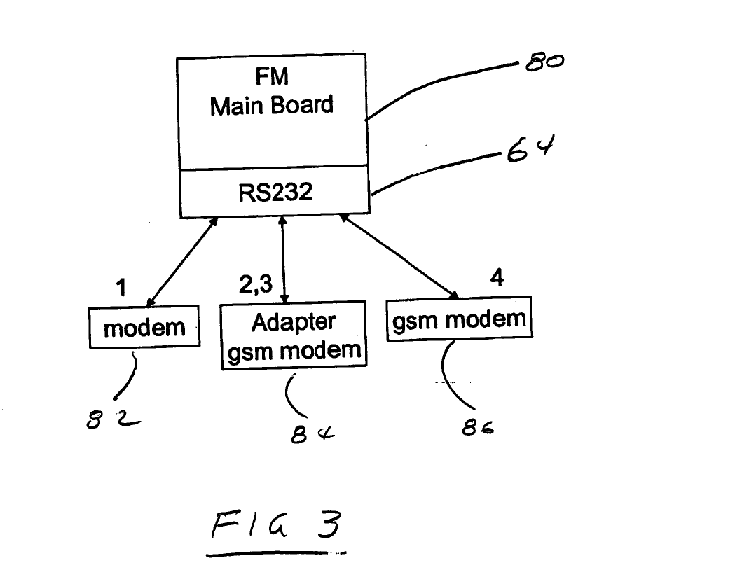

Referring again to FIG. 1, there is shown a block diagram of a system 10 in which the method of the present invention could be utilized. Additional data, for example, service data, billing data or utilization data or otherwise, may be stored at device 40 or transferred from device 40 to a value added services application 2, for example, transferred over the world wide web 18 to value added service application 2 on a server 2. In alternate embodiments, data may be collected and/or processed further up or down stream of device 40 and services application 2. Connections 30, 32, 34 may be utilized for the additional data or additional network connections may be provided and may be any suitable network, such as a local area network, wireless network or otherwise. In alternate embodiments, the additional data may be stored locally or stored over a network where value added services 2 does not require access over web 18 and where value added services application 2 does not reside on device 40. In alternate embodiments, additional data may be transferred, for example, where a user such as the originator or a postal service may access the data from value added services application 2 over network 6 via user PC 4. Alternately, the data may be posted to a website and accessed by application 2 or PC 6 via web 18. Although the different functions and data access points are shown linked by the world wide web, other suitable access or data communication methods may be provided, for example, cellular, networked or wireless or other suitable methods. Here, connection 30, 32, 34 may be real time, scheduled by device 40 or by remote center or application 2. In alternate embodiments, more or less users, applications or networks may be provided. In each case, data may be tracked, transferred, accessed or utilized in any suitable manner, such as disclosed in U.S. patent application Ser. No. 11/047,286 filed Jan. 31, 2005 which is hereby incorporated by reference in its entirety. Referring now to FIG. 2, device 40 may be a mailing machine. In the embodiment shown, mailing machine 40 generally comprises a franking device 42. The mailing machine 40 and its sections described in greater detail below is merely exemplary, and in alternate embodiments the mailing machine may have any other sections or systems. Mailing machine 40 generally has main board 80 having microprocessor 44 which effects operation of the franking machine. A user interface, such as a keyboard 46 may be provided to input data by a user. Display 48 may be provided to display status or other information as to the operation of mailing machine 40. Memory 50 may be provided to store data. Controllers 52, 54 may be provided for driving items such as feeder 56 or marking device, such as ink ribbon 58 or impression roller and raise/lower drive 60 or print element 62. Additional peripheral devices, such as modem or network connection(s) 64, scale 66, folder 68, insertion device 70, moistener/sealer 72, label dispenser 74, speaker device 78, or other peripheral devices may be provided. Here, in addition to the methods above, processor 44 or services 12 may take additional action, such as providing alarms, status, parameters, data or otherwise as disclosed above, or such as disclosed in U.S. Pat. No. 6,761,422 which is hereby incorporated by reference in its entirety. As noted before, the machine 40 shown in FIG. 3 and described above is merely exemplary and not meant to be the exclusive embodiment. In alternate embodiments, more or less features may be provided, such as where more, less or different components are provided. Further, for example, a wireless or computer interface could be provided, or a battery may be disposed within mailing machine 40. As yet a further example, a custom message interface could be provided or docking interfaces, power interface, status indicators, other connections, labels, network connections, additional user interfaces, or otherwise may be provided.

Referring now to FIG. 3, there is shown a block diagram of main control board 80 having a communication interface 64. In one embodiment, interface 64 is a serial interface where analog modem 82 is removed and replaces with GSM modem 84. Alternately, port 64 may be removed and directly replaced with gsm modem 86 interfacing directly with board 80. In each case, an internal or external Adapter/GSM modem is added where the adapter may strip off the “AT” dial command and connection handling and pass through communication from the franking machine. Alternately, the gsm modem may be connected directly to the analog port or any suitable network port. Alternately, multiple modems or communication or network interfaces may exist on machine 40 in any suitable combination. In the embodiment shown, for example, the external modem may be connected via a wire harness, from a port, for example an RS232 port, to an external connector. In alternate embodiments, the franking machine may implement the adapter functions.

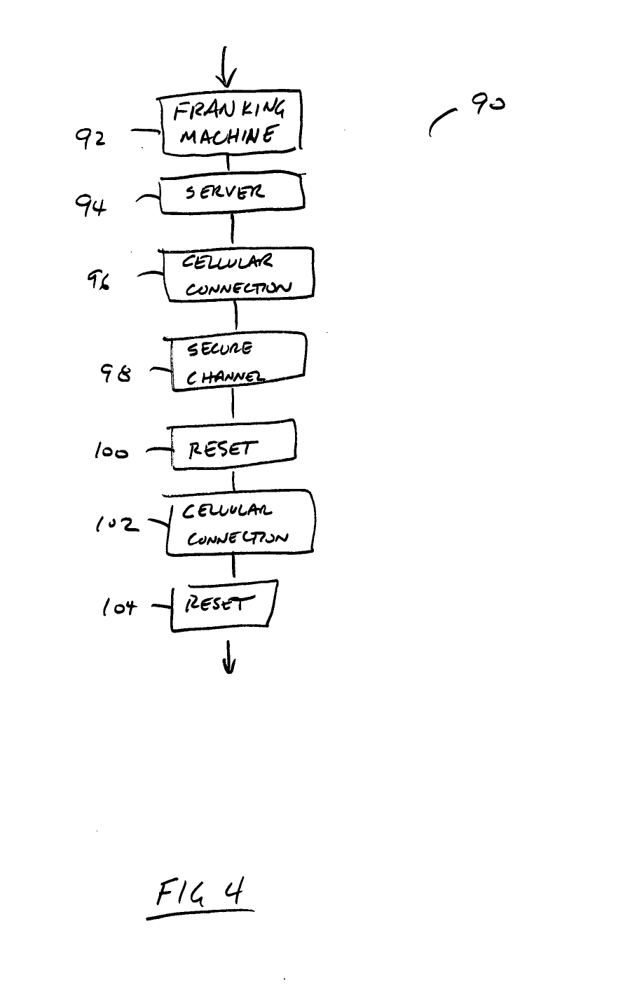

Referring now to FIG. 4, a flow diagram of a method 90 of connecting a service provider to a franking machine for resetting the franking machine is provided. A step 92 of providing a franking machine at a first location is provided where the franking machine has a communication interface. A step 94 of providing a server at a central location remote from the first location is provided. A step 96 of connecting a cellular interface to the communication interface of the franking machine is provided; and a step 98 of establishing a secure channel of communication between the cellular interface and the server. The secure channel of communication between the cellular interface and the server may comprise an encrypted channel. The step 98 of establishing a secure channel of communication between the cellular interface and the server may have steps of: communicating via GPRS to a cellular carrier; and authenticating the franking machine via the GSM. Here, a secure and encrypted channel is established. The step 98 of establishing a secure channel of communication between the cellular interface and the server may have steps of: communicating via GPRS to a cellular carrier; authenticating the franking machine via the GSM; and routing the channel of communication via a secure network to a service provider. Here, a secure and encrypted channel is established from the franking machine to the service provides at the remote locate on. Step 100 of resetting the franking machine from the remote location may be provided. The step 96 of connecting a cellular interface to the communication interface of the franking machine may have a step of connecting a cellular modem to a communication port of the franking machine. The step 96 of connecting a cellular interface to the communication interface of the franking machine may have steps of replacing a dial up modem in the franking machine with a cellular modem. Step 92 may have a step of providing more than one, for example first and second franking machines at the first location. Step 102 of connecting the cellular interface to the second franking machine may be provided; and step 104 of resetting the second franking machine from the server over the secure channel may be provided. Step 96 may comprise connecting a cellular modem to a communication port of the franking machine. The franking machine may have an integral cellular communication interface or separately connectable cellular communication interface. Here, communication via an encrypted channel between the franking machine and a cellular carrier may be established where the communication is routed to the server at a central location, and the franking machine is rest from the central location via the encrypted channel. Step 96 of establishing communication via an encrypted channel between the franking machine and a cellular carrier may comprise authenticating the franking machine via a GSM system. Here, the cellular communication interface may comprise a cellular modem connected to a serial port of the franking machine. Step 98 may comprise routing the communication to the server at the central location such as routing the communication via a virtual private network over the world wide web. Here, the communication channel may be substantially continuously open. The cellular communication interface may be movable from the franking machine to a different second franking machine and may be connected to an analog modem of the franking machine. Where the modem is integrated, the franking machine may select between the cellular communication interface and a separate analog modem interface of the franking machine.

It should be understood that the foregoing description is only illustrative of the invention. Various alternatives and modifications can be devised by those skilled in the art without departing from the invention. One such example is where other configurations of databases or servers may also be used. Accordingly, the present invention is intended to embrace all such alternatives, modifications and variances which fall within the scope of the appended claims.

What is claimed is:

1. A method of connecting a service provider to a franking machine comprising:
providing a franking machine at a first location, the franking machine having a communication interface;
providing a server at a central location remote from the first location;
connecting a cellular interface to the communication interface of the franking machine; and
establishing a secure channel of communication between the cellular interface and the server.

2. The method of claim 1, wherein the secure channel of communication between the cellular interface and the server comprises an encrypted channel.

3. The method of claim 1, wherein the step of establishing a secure channel of communication between the cellular interface and the server comprises:
communicating via GPRS to a cellular carrier; and
authenticating the franking machine via the GSM;
wherein, a secure and encrypted channel is established.

4. The method of claim 1, wherein establishing a secure channel of communication between the cellular interface and the server comprises:
communicating via GPRS to a cellular carrier;
authenticating the franking machine via the GSM; and
routing the channel of communication via a secure network to a service provider;
wherein, a secure and encrypted channel is established from the franking machine to the service provides at the remote location.

5. The method of claim 1, further comprising resetting the franking machine from the remote location.

6. The method of claim 1, wherein connecting a cellular interface to the communication interface of the franking machine comprises connecting a cellular modem to a communication port of the franking machine.

7. The method of claim 1, wherein connecting a cellular interface to the communication interface of the franking machine comprises replacing a dial up modem in the franking machine with a cellular modem.

8. A method of resetting franking machines comprising:
providing a first and second franking machine at a first location;
providing a server at a central location remote from the first location;
connecting a cellular interface to the first franking machine;
establishing a secure channel of communication between the cellular interface and the server;resetting the first franking machine from the server over the secure channel;
connecting the cellular interface to the second franking machine; and
resetting the second franking machine from the server over the secure channel.

9. The method of claim 8, wherein the secure channel of communication between the cellular interface and the server comprises an encrypted channel.

10. The method of claim 8, wherein establishing a secure channel of communication between the cellular interface and the server comprises:
communicating via GPRS to a cellular carrier; and
authenticating the franking machine via the GSM;
wherein, a secure and encrypted channel is established.

11. The method of claim 8, wherein establishing a secure channel of communication between the cellular interface and the server comprises steps of:
communicating via GPRS to a cellular carrier;
authenticating the first franking machine via the GSM; and
routing the channel of communication via a secure network to a service provider;
wherein, a secure and encrypted channel is established from the first franking machine to the service provides at the remote location.

12. The method of claim 8, wherein connecting a cellular interface to the first franking machine comprises connecting a cellular modem to a communication port of the franking machine.

13. A method of resetting a franking machine comprising:
providing a franking machine at a first location, the franking machine having a cellular communication interface;
providing a server at a central location remote from the first location;
establishing communication via an encrypted channel between the franking machine and a cellular carrier;
routing the communication to the server at the central location; and
resetting the franking machine from the central location via the encrypted channel.

14. The method of claim 13, wherein establishing communication via an encrypted channel between the franking machine and a cellular carrier comprises authenticating the franking machine via a GSM system.

15. The method of claim 13, wherein the cellular communication interface comprises a cellular modem connected to a serial port of the franking machine.

16. The method of claim 13, wherein routing the communication to the server at the central location comprises routing the communication via a virtual private network over the world wide web.

17. The method of claim 13, wherein the communication channel is substantially continuously open.

18. The method of claim 13, wherein the cellular communication interface is movable from the franking machine to a different second franking machine.

19. The method of claim 13, wherein the cellular communication interface is connected to an analog modem of the franking machine.

20. The method of claim 13, wherein the franking machine may select between the cellular communication interface and a separate analog modem interface of the franking machine.
